(19) United States
(12) Patent Application Publication
(10) Pub. No.: US 2012/0325845 A1
(43) Pub. Date: Dec. 27, 2012

(54) Systems and Methods for Recipe Portion Control for a Product Dispenser

(75) Inventors: David R. Newman, Atlanta, GA (US); Daniel S. Quartarone, Stone Mountain, GA (US)

(73) Assignee: THE COCA-COLA COMPANY, Atlanta, GA (US)

(21) Appl. No.: 13/168,567

(22) Filed: Jun. 24, 2011

(51) Int. Cl. B67D 7/06

(52) U.S. Cl. 222/1; 222/135

(57) ABSTRACT

Embodiments of the invention can include systems and methods for recipe portion control for a product dispenser. In one embodiment, a system or product dispenser can be provided. A system or product dispenser can include a plurality of beverage ingredient sources comprising a respective beverage ingredient, a plurality of beverage supply lines in respective communication with the plurality of ingredient sources, at least one pump in communication with the plurality of beverage supply lines, and a controller in communication with the at least one pump and operable to execute a set of instructions. The set of instructions can be operable to dispense a first portion of a beverage, delay further dispensing for a predefined time, and dispense at least a second portion of the beverage.

### TRADEMARKS

COCA-COLA® is a registered trademark of The Coca-Cola Company, Atlanta, Ga., U.S.A. Other names, symbols, designs, or logos used herein may be registered trademarks, trademarks or product names of The Coca-Cola Company or other companies.

### TECHNICAL FIELD OF THE INVENTION

This invention relates to product dispensers, and in particular, relates to systems and methods for recipe portion control for a product dispenser.

### BACKGROUND OF THE INVENTION

Conventional product dispensers can pour a beverage by combining a syrup, sweetener, and/or water. To create a finite variety of beverage selections different kinds of syrup can be offered. This typically results in being able to offer a finite number of branded and non-branded beverage selections. As an example, a single prior art dispenser using several different kinds of syrup might be able to offer limited choices of COCA-COLA™, DIET COCA-COLA™, SPRITE™, and a few other branded or non-branded beverage selections.

One problem with these types of conventional product dispensers is that only a limited number of drinks can be offered. As such, conventional product dispensers may be limited in being able to offer the consumer what they want. In this regard, consumers want a wider menu of beverage selections and the ability to customize their beverage. Research suggests that they want more beverage variations even for a traditional branded beverage. For example, offering COCA-COLA™, COCA-COLA™ with lime, CHERRY COCA-COLA™, VANILLA COCA-COLA™ and numerous other types of COCA-COLA™ beverage variations. Offering all the variations possible for a single drink brand such as COCA-COLA™ are impractical in conventional product dispensers in part because conventional product dispensers have limited capacity and selection capability. They may not offer the consumer what the consumer wants, that is, a complete variety of choices for all types of branded and non-branded beverages.

Product dispensers historically have worked by combining a diluent (such as water) with a beverage base. These beverage bases usually have a reconstitution ratio of about 3:1 to 6:1. The beverage bases usually come in large containers that require large amounts of storage space and may need to be refrigerated. These requirements often necessitate the need to store these containers far from the actual dispenser and to run long lines from the containers to the dispenser.

Given the improvements in shelf life and concentration described above, there is a desire for a product dispenser that can produce even more and different types of beverages while using a smaller footprint. This can be accomplished by breaking down the traditional beverage bases into constituent parts at much higher reconstitution ratios. These parts can then be stored in much smaller packages and stored closer to, adjacent to, or within the product dispenser itself. The product dispenser preferably can give the consumer multiple beverage options such that the consumer has the ability to customize his or her beverage as desired.

In certain instances, some beverages may have different carbonation or foaming characteristics when poured or otherwise dispensed. This occurrence may be due to the differences in the ingredients used to formulate each beverage. In any instance, non-carbonated beverages will “top off” consistently when poured or otherwise dispensed in a container, such as a cup. When certain carbonated beverages are poured or dispensed, depending on the amount of carbonation, each beverage may have one or more additional amounts added during subsequent pours or dispenses to “top off” the beverage in a container or cup. In conventional product dispensers, the operation to “top off” different beverages is a time consuming, manually initiated operation that requires the operator to individually “top off” each poured or dispensed beverage. When an inexperienced user or operator frequently pours or dispenses different beverages, various amounts of the beverage may be wasted in learning how to “top off” each different beverage. Even experienced users or operators may waste beverages when changing between different poured or dispensed beverages.

Certain conventional product dispensers may have a teach mode for adjusting portions to be dispensed. Such dispensers can include one or more valves which are individually set to accommodate dispensing of a product or beverage into different sizes of cups, such as 4 different sized cups. When a first valve is set or otherwise programmed, the teach mode merely copies the settings or programming for use with the other valves, thus ultimately, all of the valves are similarly set or programmed for dispensing into different sized cups.

### SUMMARY OF THE INVENTION

Some or all of the above needs and/or problems may be addressed by embodiments of the invention. Embodiments of the invention can include systems and methods for recipe portion control for a product dispenser. In one embodiment, a system or product dispenser can be provided. A system or product dispenser can include a plurality of beverage ingredient sources comprising a respective beverage ingredient, a plurality of beverage supply lines in respective communication with the plurality of ingredient sources, at least one pump in communication with the plurality of beverage supply lines, and a controller in communication with the at least one pump and operable to execute a set of instructions. The set of instructions can be operable to dispense a first portion of a beverage, delay further dispensing for a predefined time, and dispense at least a second portion of the beverage.

Another embodiment can provide a computer program product. The computer program product can include a computer readable medium having computer readable program code, the computer readable program code operable to be executed to implement a method for adjusting a recipe for a product dispenser. The method can include dispensing a first portion of a product, delaying further dispensing for a predefined time, and dispensing at least a second portion of the product.

Another embodiment can provide a method for adjusting a product recipe for a product dispenser. The method can include dispensing a first portion of a product, delaying further dispensing for a predefined time, and dispensing at least a second portion of the product.

In yet another embodiment, a method for adjusting a product recipe for a product dispenser can be provided. The method can include storing a product recipe adjustment, wherein the adjustment comprises at least one of the following: a first portion amount for the particular product, a delay for a predefined time, or a second portion amount for the particular product. dispensing a first portion of a product. The method can also include facilitating dispensing of a first portion of the product, facilitating a delay of further product dispensing for a predefined time, and facilitating dispensing of at least a second portion of the product.

Additional systems, methods, product dispensers, apparatus, aspects, and features are realized through the techniques of various embodiments of the invention. Other embodiments, aspects, and features of the invention are described in detail herein and are considered a part of the claimed invention. Other embodiments, aspects, and features can be understood with reference to the description and to the drawings.

### BRIEF DESCRIPTION OF THE FIGURES

FIG. 1 is a schematic view of an example product dispenser in accordance with an embodiment of the invention.

FIG. 2 is a schematic view of an example user interface for use with the product dispenser of FIG. 1, in accordance with an embodiment of the invention.

FIG. 3 is a schematic flowchart for a method of adjusting a product recipe for a product dispenser in accordance with an embodiment of the invention.

FIG. 4 is a schematic flowchart for another method of adjusting a product recipe for a product dispenser in accordance with an embodiment of the invention.

The detailed description explains various embodiments of the invention, together with aspects and features, by way of example with reference to the drawings.

### DETAILED DESCRIPTION OF EMBODIMENTS OF THE INVENTION

As used herein, the terms “beverage forming dispenser,” “product dispenser,” “beverage dispenser,” “dispenser apparatus,” and “dispenser” refer to a device which dispenses a product such as a beverage, a fluid, or a consumable product.

As used herein, the terms “product” and “beverage,” and their pluralized forms, are used synonymously, and embodiments of the invention should not be limited in scope by the use of either term.

As used herein, the terms “top off” and “topping off” refer to an operation used to add more product, beverage, fluid, other substances or materials, or any combination thereof into a container to fill the container to a desired level or volume.

Embodiments of the invention can include systems and methods for recipe portion control for a product dispenser. Certain embodiments of the invention can be particularly useful when operating a product dispenser, such as a beverage dispenser. In one instance, when a user or operator is using a product or beverage dispenser to fill a container, such as a cup, the product or beverage dispenser can automatically detect the type of product or beverage being poured or dispensed, and adjust the portions being poured or dispensed to account for certain product or beverage characteristics, such as a foaming or carbonation amounts. In this manner, a user or operator can minimize the time spent in topping off a product or beverage being poured or dispensed with a product or beverage dispenser. Thus, certain embodiments of the invention can provide a technical solution to the time consuming problem of topping off a product or beverage using a product dispenser, such as a beverage dispenser.

The circumstances provided above are for illustration only, and are not intended to be limiting. One will recognize other circumstances for applying embodiments of the invention, and the applicability of those embodiments to other product and/or beverage dispenser technologies.

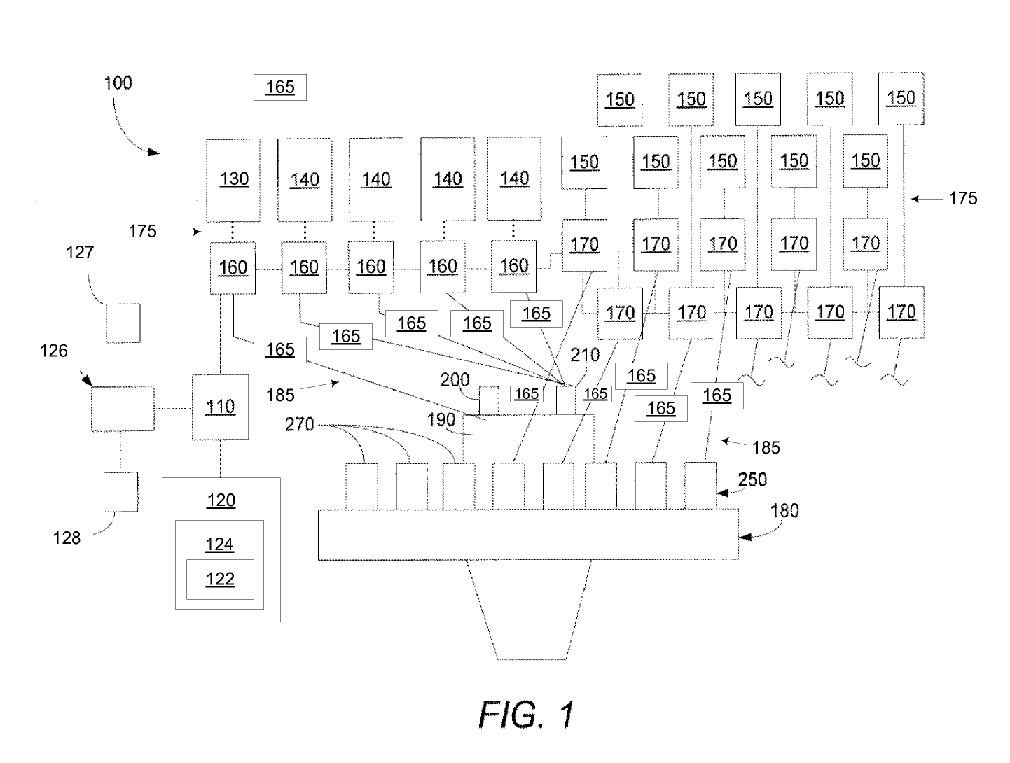

Turning now to the drawings in greater detail, in which like numerals indicate like elements throughout the several views, FIG. 1 shows an example system such as a product dispenser 100 as is described herein. A user interface 110 may control some or all of the functional aspects of the product dispenser 100. A consumer may select and/or create numerous types of beverages, blends, and additives using the user interface 110. Furthermore, a food service employee and/or dispenser technician may use the user interface 110 to implement certain installation and/or maintenance functions. A control device 120 may support the user interface 110. The control device 120 may be a conventional microcomputer, processor, or a similar type of device. The control device 120 may be internal to or remote from the product dispenser 100.

The product dispenser 100 may use any number of different ingredients. In this example, several different types of ingredients may be used: water (plain and/or carbonated) from a water source 130; macro-ingredients from a number of macro-ingredient sources 140; and micro-ingredients from a number of micro-ingredient sources 150. Any number or combinations of sources 130, 140, 150 may be used herein. For example, it may not be necessary to have a macro-ingredient source, e.g., HFCS (High Fructose Corn Syrup), which is difficult to pump at high reconstitution ratios, may not be used. As such, only a diluent and a micro-ingredient source may be required. In another example, 106 unique ingredient sources 140, 150 may be present in a product dispenser, such as 100, in accordance with an embodiment of the invention. One will recognize that other embodiments of the invention can include fewer or greater numbers of ingredient sources 140, 150.

The water from the water source 130 may or may not be refrigerated. Other types of diluents may be used herein. A conventional carbonator or a similar type of device may be used to produce carbonated water as desired. The amount of carbonation may be varied.

Generally described, the macro-ingredients may have reconstitution ratios in the range of about 3:1 to about 6:1. The viscosities of the macro-ingredients typically range from about 100 centipoise or higher. Macro-ingredients may include sugar syrup, HFCS, juice concentrates, and similar types of fluids. Similarly, a macro-ingredient base product may include sweetener, acid, and other common components. The syrups, sweeteners, and base products generally can be stored in a conventional bag-in-box container remote from the dispenser 100. The macro-ingredients also may be positioned within the product dispenser 100 itself. Any type of container may be used herein in accordance with embodiments of the invention. The macro-ingredients may or may not need to be refrigerated.

The micro-ingredients may have a reconstitution ratio ranging from about ten to one (10:1), twenty to one (20:1), thirty to one (30:1), or higher. Specifically, many micro-ingredients may be in the range of fifty to one (50:1) to three hundred to one (300:1). The viscosities of the micro-ingredients typically range from about 1 to about 100 centipoise or so. Examples of micro-ingredients include natural and artificial flavors; flavor additives; natural and artificial colors; artificial sweeteners (high potency or otherwise); additives for controlling tartness, e.g., citric acid, potassium citrate; functional additives such as vitamins, minerals, herbal extracts; nutraceuticals; and over-the-counter (or otherwise) medicines such as acetaminophen and similar types of materials. As described above, the acid and non-acid components of the non-sweetened concentrate also may be separated and stored individually. The micro-ingredients may be liquid, powder (solid), or gaseous form and/or combinations thereof. The micro-ingredients may or may not require refrigeration. Non-beverage substances such as paints, dyes, oils, cosmetics, etc., also may be used. Various types of alcohols may be used as micro or macro-ingredients.

In certain instances, the micro-ingredients and the micro-ingredient sources 150 may be positioned within or about the product dispenser 100 itself as opposed to being remotely positioned in conventional bag in box containers or otherwise. By being positioned about the dispenser, the micro-ingredient sources 150 can, for example, be positioned in close proximity to the dispenser 100 such as adjacent thereto, underneath, or in other near by positions. Any other type of storage arrangements may be used in accordance with embodiments of the invention. The macro and/or micro-ingredient sources may optionally be located remotely from the dispenser 100, such as in a back room, connected to the dispenser 100 with conventional tubing. Furthermore, any type of container may be used herein in accordance with embodiments of the invention.

The water source 130, the macro-ingredient sources 140, and the micro-ingredient sources 150 each may be in communication with a respective pump 160, sensor 165, and/or a metering device 170 via a respective supply line 175. The control device 120 may control the pumps 160, sensors 165, and metering devices 170. Generally described, the water source 130 and the macro-ingredient sources 140 each may be in communication with one of the pumps 160. The pump 160 may be a conventional solenoid pump or a similar type of device.

The micro-ingredient sources 150 each may be in communication with a respective metering device 170 via a respective supply line 175. The metering device 170 may be a positive displacement pump or a similar type of device. Such a positive displacement pump provides portion control for the more highly concentrated micro-ingredients. An example of the operation of a positive displacement pump is shown in commonly owned U.S. patent application Ser. No. 11/276,548, entitled “Pump System with Calibration Curve” incorporated herein by reference.

For example, the positive displacement pump may be a solenoid pump, a gear pump, an annular pump, a peristaltic pump, a syringe pump, a piezo pump or any other type of positive displacement device that is designed to pump a fixed displacement for each pump cycle.

The pumps 160, sensors 165, and the metering devices 170 may be in communication with a dispensing nozzle 180 via respective supply lines 185. The dispensing nozzle 180 preferably may be a multi-flavor dispensing valve capable of mixing a number of fluids at the same time. Examples of dispensing nozzles that may be used herein are shown in commonly owned U.S. patent application Ser. No. 10/233,867 (U.S. Patent Publication No. US 2004/0040983 A1), entitled “Dispensing Nozzle” and commonly-owned U.S. patent application Ser. No. 11/276,551, entitled “Dispensing Nozzle Assembly”. Collectively or individually, the supply lines 175, 185 can be known as beverage supply lines.

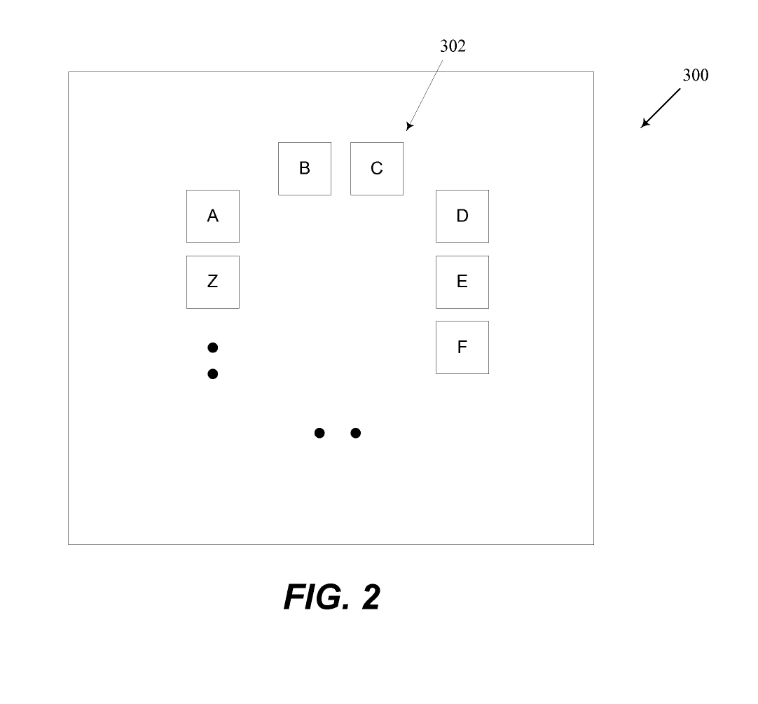

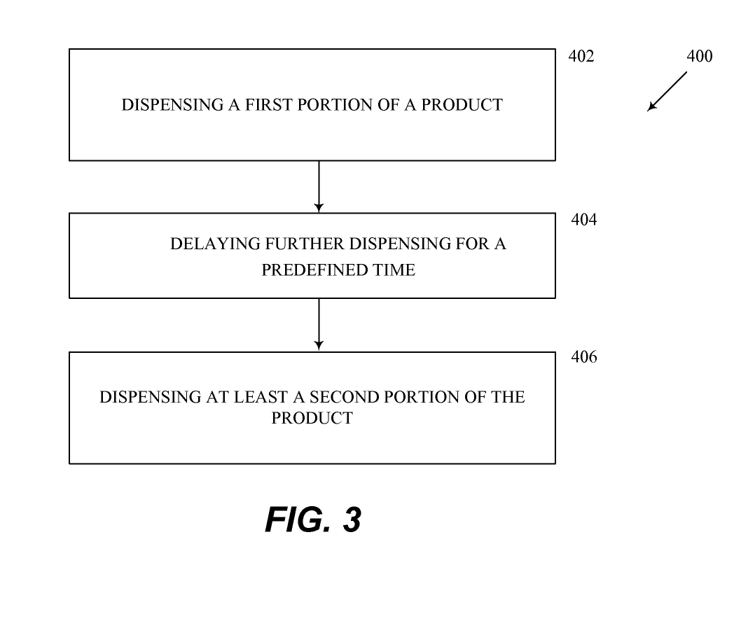

In the embodiment shown, a user interface, such as 300 in FIG. 3, may include one or more product or beverage selection options. Depending on the selected product or beverage selection option, the control device 120 in FIG. 2 may receive a corresponding signal from the interface 300 that the selected product or beverage is desired. Prior to or during dispensing the selected product or beverage, the control device 120 can utilize a table, a recipe database, or other stored information to determine a recipe adjustment for a selected product or beverage. The control device 120 can then interact with, coordinate, or otherwise control one or more of the sources 130, micro-ingredient sources 140, 150, supply lines 175, 185, and pumps 160 to implement a recipe adjustment corresponding with the selected product or beverage.

For example, the control device 120 can access a recipe adjustment stored in at least one of a memory, a network, a local data storage device, or a remote data storage device. In one instance, a recipe adjustment can be stored in memory 124 shown in FIG. 1. In another instance, a recipe adjustment can be stored in a local data storage device or a remotely located data storage device accessible via a network. In any instance, a suitable table, recipe database, or other stored information to determine a recipe adjustment can include certain information, such as a first amount of product or beverage to dispense; a first set of base products, product components, or ingredient sources; at least one time delay, a second amount of product or beverage to dispense; a second set of base products, product components, or ingredient sources; a subsequent amount of product or beverage to dispense; a subsequent set of base products, product components, or ingredient sources; and user-entered data operable to adjust a recipe. Using the recipe adjustment, the control device can interact with, coordinate, or otherwise control one or more of the sources 130, micro-ingredient sources 140, 150, supply lines 175, 185, and pumps 160 to implement any number of volume or amounts and time delays corresponding with a recipe adjustment for the selected product or beverage.

In one embodiment, the sensors 165 can be operable to detect an ingredient or component in the respective supply lines 175, 185, and can communicate one or more corresponding signals to the control device, such as 120, when certain ingredients or components are detected. The sensors 165 in FIG. 1 are shown positioned with respect to a supply line, such as 175, 185, for each ingredient source 140, 150. One will recognize that the sensors 165 can be positioned in any location with respect to a supply line 175, 185 between at least one ingredient source 140, 150 and a dispenser nozzle, such as 180. In this particular embodiment, rather than receiving a signal corresponding to a product button selection on an interface, such as 110, 300, the control device 120 can receive a signal from one or more sensors 165 that particular ingredients or components, or combination of ingredients and components, are being provided. The control device 120 can check against a table, database, or other stored information, which may identify a particular product or beverage being provided, and the control device 120 can determine whether a recipe adjustment for the selected product or beverage should be implemented for the identified product or beverage. The control device 120 can then implement the recipe adjustment by interacting with, coordinating, or otherwise controlling one or more of the sources 130, micro-ingredient sources 140, 150, supply lines 175, 185, and pumps 160 to implement any number of volume or amount instructions and time delays corresponding with a recipe adjustment for the identified product or beverage.

In any instance, the control device 120 can interact with one or more of the pumps 160 associated with certain supply lines 175, 185 to implement a recipe adjustment to dispense a first portion of product or beverage, delay further dispensing of the product or beverage, and dispense at least a second portion of the beverage.

Generally shown in FIG. 1, the dispensing nozzle can include a flow director 190 with a number of conduits extending therethrough. In this example, the flow director 190 may have a first conduit 200 and a second conduit 210 extending therethrough. The first conduit 200 may be used for water, other types of diluents, or other fluids. The second conduit 210 may be used for a macro-ingredient such as sweetened concentrate, sugar syrup, HFCS syrup, juice concentrate, or other type of fluids. Positioned beneath the flow director 190 may be a target, which may include a number of vertically extending fins that form a number of U- or V-shaped channels. The water, the macro-ingredients, or other fluids may flow out of the flow director 190 and down along the channels of the target so as to begin mixing.

Positioned adjacent to the flow director 190 may be a tertiary flow assembly 250. The tertiary flow assembly 250 may include a number of modules, which may have a number of conduits 270 extending therethrough. The conduits 270 may have differing sizes and configurations depending upon the nature of the intended flow therethrough. The modules may be replaceable and interchangeable. Each of the modules and the conduits 270 may be in communication with one of the micro-ingredient sources 150 or other types of fluids. The conduits 270 may be aimed towards the target so as to mix the micro-ingredients or other fluid with the water, the macro-ingredients, or other fluid. Any number of micro-ingredients or other types of fluids may be used at the same time.

As stated above, the control device 120 may be, for example, a processor or controller. The control device 120 may include one or more computer-executable instructions 122 stored in an associated memory, such as 124, or other computer-readable medium. The computer-executable instructions can include instructions operable to dispense a first portion of product or beverage, delay further dispensing of the product or beverage, and dispense at least a second portion of the beverage. In at least one embodiment, computer-executable instructions can include instructions further operable to provide a product recipe adjustment, wherein the adjustment comprises at least one of the following: a first portion amount for a particular product, a delay for a predefined time, or a second portion amount for a particular product. In another embodiment, computer-executable instructions can include instructions further operable to provide a product recipe adjustment, wherein the adjustment comprises a percentage amount to dispense for a particular product, a predefined time to delay, and a remaining percentage amount to dispense for the particular product. In yet another embodiment, computer-executable instructions can include instructions further operable to provide a product recipe adjustment based at least in part on a particular product to be dispensed, wherein the adjustment comprises at least one of the following: a first portion amount for the particular product, a delay for a predefined time, or a second portion amount for the particular product. In one other embodiment, computer-executable instructions can include instructions further operable to provide a product recipe adjustment based at least in part on a particular product to be dispensed, wherein the adjustment comprises a percentage amount to dispense for a particular product, a predefined time to delay, and a remaining percentage amount to dispense for the particular product.

The product dispenser 100 also may include a user data system 126 in communication with the user interface 110 and the control device 120. The user data system 126 may include a communications device 127. The communications device 127 may include a video touch screen, a video screen and keyboard, a gesture detection device, touchpad, or any other type of conventional input/output device. The communications device 127 may be part of the user interface 110 or a separate element.

In one embodiment, the communications device 127 may include a network interface, such as a network input/output interface in communication with the control device 120. The communications device 127 may access one or more remotely located data storage devices via a network to obtain or otherwise access a table, recipe database, or other stored information to determine a recipe adjustment. Such information can be communicated to the control device 120 for implementing one or more instructions associated with the information.

In certain embodiments, a communications device, such as 127, may prompt the user to input data on various types of biometric and/or other types of information. Based upon the user's input, the control device 120 may analyze the data and may convert the user's input to one or more pouring or dispensing commands.

In addition to the communications device 127 as described above, the user data system 126 also may include one or more biometric sensors 128. The biometric sensors may include automated devices to gather the desired user biometric data or other information. The biometric sensors 128 may include a scale, a blood pressure cuff, a breathalyzer, a blood analyzer, a hair analyzer, an EKG, etc. Any type of monitoring device may be used herein. Any number of biometric sensors 128 may be used together. The biometric sensors 128 may be in communication with the control device 120 as described above.

FIG. 2 shows an embodiment of the user interface 110, as interface 300. As shown in FIG. 2, the user interface can be a graphical interface, which may include one or more physical buttons and/or computer generated touch screen display buttons or icons. In any instance, the interface 300 may include one or more predefined product buttons 302. Each product selection button 302 may represent a different product or beverage. When desired, a product selection button 302 can be selected by a user to select an associated product or beverage to pour or dispense. In any instance, a user can readily select via the interface 300 which product or beverage to pour or dispense into a container, such as a cup.

In one embodiment, a user can select from any number of particular “branded” beverages. For example, icons associated with the “Cherry Coke®” beverage and the “Coca-Cola®” beverage sold by The Coca-Cola Company of Atlanta, Georgia can be displayed on a user interface, such as 300 in FIG. 2. The product dispenser 100 thus may provide via the user interface 300 as many “branded” beverages as may be available from the product dispenser 100.

In certain embodiments, the interface 300 operating alone or in conjunction with a communications device, such as 127, and/or a biometrics sensor, such as 128, may provide a user, such as an individual product dispenser operator, with secure access by password, smart card, biometric identification, credit card, RFID, or otherwise. User or operator preferences also may be retained and used for future product dispenser maintenance.

In addition to the graphical interface, the product dispenser 100 as a whole may provide other product dispenser statistics and troubleshooting information. For example, the delay time for the start of the pumps 160 or the metering devices 170, the times for the vent and/or flush cycles, the portion cycles, etc. may be accessed through the user interface 110, 300. This interface 110, 300 may be password or otherwise protected. The user interface 110, 300 may communicate and/or be accessed as needed with a network or other source for troubleshooting or repair and for notifications or alerts, for example, of a potential incorrect dose of ingredients.

In use, a user such as a product dispenser operator, a food service employee, and/or dispenser technician, may select from the user interface 110 a desired beverage to pour or dispense from the product dispenser 100. After user selection of a desired beverage via the user interface 110, the control device 120 can execute one or more instructions corresponding to the desired beverage. For example, the control device 120 may access a table, recipe database, or stored information in memory 124 or other data source to obtain one or more instructions corresponding to a recipe adjustment or other predefined product recipe for the desired beverage. Based on the instructions, the control device 120 can implement the instructions corresponding to the recipe adjustment or other predefined product recipe for the desired beverage by communicating with or controlling one or more of the sources 130, micro-ingredient sources 140, 150, supply lines 175, 185, and pumps 160.

For example, the control device 120 can obtain instructions corresponding to dispensing about 12 fluid ounces of a carbonated, orange-flavored beverage. The instructions may correspond with a recipe adjustment or other predefined product recipe for the particular carbonated, flavored beverage, including a first portion (such as about 10 fluid ounces) of the beverage to be dispensed, a time delay (such as about 5 seconds) after dispensing the first portion of beverage, and a second portion (such as about 2 fluid ounces) of the beverage to be dispensed.

In another example, the control device 120 can obtain instructions corresponding to dispensing about 12 fluid ounces of a carbonated, cherry-flavored beverage. The instructions may correspond with a recipe adjustment or other predefined product recipe for the particular carbonated, flavored beverage, including a first portion (such as about 9.5 fluid ounces) of the beverage to be dispensed, a time delay (such as about 7.5 seconds) after dispensing the first portion of beverage, and a second portion (such as about 2.5 fluid ounces) of the beverage to be dispensed.

In yet another example, the control device 120 can obtain default instructions corresponding to dispensing about 12 fluid ounces of a carbonated beverage. The instructions may correspond with a recipe adjustment or other predefined product recipe for the particular carbonated beverage, including a first portion (such as about 11 fluid ounces) of the beverage to be dispensed, a time delay (such as about 2 seconds) after dispensing the first portion of beverage, and a second portion (such as about 1 fluid ounce) of the beverage to be dispensed.

In other example embodiments, different fluid volumes, product amounts, and time delays can be used. Further, in other example embodiments, different fluid or product measurements can be used, such as grams, milliliters or liters, or volume percentage of a container or cup. In yet other example embodiments, certain amounts or volumes of base products, product components, and/or ingredient sources may be defined.

In any instance, each of the recipe adjustments or other predefined product recipes can be designed to account for certain product or beverage characteristics, such as carbonation, foaming, and the presence of particular ingredients. A time delay between the dispensing of a first portion of a beverage and the dispensing of a second portion of the beverage can be set and/or adjusted according to the amount of carbonation and/or foam generated by the dispensing of the first portion. Further, in other embodiments, time delays of varying amounts between multiple portions can be implemented. In other embodiments, a recipe adjustment or other predefined product recipe can include user-entered data operable to adjust a recipe, which may include portion amounts and/or time delay information according a particular user's or users' experience in pouring a particular beverage or dispensing a particular product.

The interface 110, with the control device 120, can instruct some or all of the individual pumps 160 and/or the metering devices 170 to dispense suitable ingredients in the appropriate proportions through the beverage supply lines 175, 185 towards the dispensing nozzle 180. The pumps 160 and the metering devices 170 may be pulsed on and off as desired to vary the flow rate, or may otherwise be activated for a predetermined amount of time to introduce a predefined amount of each respective ingredient into the respective beverage supply lines 175, 185. Depending on the type of ingredients and/or beverages, different flow rates and flow timing may be employed, e.g., certain fluid streams may be added early or late, certain fluid streams may be pulsed, etc.

In any instance, the control device 120 can operate one or more of the individual pumps 160 and/or the metering devices 170 for the water source 130, the macro-ingredient sources 140, and the macro-ingredient sources 150 to adjust a product recipe for a desired or selected beverage offered by the product dispenser 100. The product dispenser 100 thus provides a user with the ability to select a particular product or beverage offered by the product dispenser 100 as desired, and to adjust the product recipe as needed to optimize the beverage pour, taste, or other characteristic. Embodiments of the invention have applicability to conventional countertop devices, vending devices, and various types of bottling and filling devices. Although embodiments of the invention are described in terms of the product dispenser 100, embodiments of the invention are applicable to the combination of any types of ingredients, wet or dry. For example, commonly owned U.S. patent application Ser. No. 11/276,549, entitled “Juice Dispensing System,” is specifically directed towards certain concepts related to the juice field. One may recognize the applicability of embodiments of the invention to the technology described in U.S. patent application Ser. No. 11/276,549.

FIG. 3 is a process flowchart illustrating an example method in accordance with an embodiment of the invention. The example method 400 shown in FIG. 3 provides a method for adjusting a product recipe for a product dispenser. In particular, the method 400 is a method for adjusting a product recipe for a product dispenser with a plurality of beverage ingredient sources comprising a respective beverage ingredient, a plurality of beverage supply lines in respective communication with the plurality of ingredient sources, and at least one pump in communication with the plurality of beverage supply lines. The method 400 can be implemented by various system or product dispenser components shown in FIG. 1, such as 100 of FIG. 1.

The method 400 begins at block 402. In block 402, a first portion of a product is dispensed. For example, in the embodiment shown with reference to FIGS. 1 and 2, a control device, such as 120, can receive a signal from a user interface, such as 110, 300, corresponding with a selected beverage offered by the product dispenser 100. The control device 120 can access one or more recipe adjustments or other predefined product recipes stored in memory, such as 124, or another data storage device, and can facilitate activation of one or more individual pumps 160 and/or the metering devices 170 for some or all corresponding ingredients and/or sources 130, 140, 150. In one embodiment, a first portion of a product can be about 10 fluid ounces or 80% of a container, such as a cup. In any instance, the control device 120 can facilitate dispensing the first portion of the selected beverage or product via a dispenser nozzle, such as 180.

In one aspect of an embodiment, the method 400 can include obtaining a product recipe adjustment, wherein the adjustment comprises at least one of the following: a first portion amount for a particular product, a delay for a predefined time, a second portion amount for a particular product, or a user-defined adjustment.

In one aspect of an embodiment, the method 400 can include obtaining a product recipe adjustment based at least in part on a particular product to be dispensed, wherein the adjustment comprises at least one of the following: a first portion amount for the particular product, a delay for a predefined time, a second portion amount for the particular product, or a user-defined adjustment.

In one aspect of an embodiment, the method 400 can include obtaining a product recipe adjustment, wherein the adjustment comprises a percentage amount to dispense for a particular product, a predefined time to delay, a remaining percentage amount to dispense for the particular product, or a user-defined adjustment.

In one aspect of an embodiment, the method 400 can include obtaining a product recipe adjustment based at least in part on a particular product to be dispensed, wherein the adjustment comprises a percentage amount to dispense for a particular product, a predefined time to delay, and a remaining percentage amount to dispense for the particular product

Block 402 is followed by block 404, in which further dispensing is delayed for a predefined time. For example, in the embodiment shown with reference to FIGS. 1 and 2, the control device 120 can delay further dispensing of the beverage for a predefined time, such as about 5 seconds, based at least in part on a recipe adjustment or other predefined product recipe. The control device, such as 120, can receive a time delay from a recipe adjustment or other predefined product recipe, and can facilitate a delay of further operation of one or more individual pumps 160 and/or the metering devices 170 for some or all desired ingredients and/or sources 130, 140, 150. In one embodiment, a predefined time can be about 5 seconds. In any instance, the control device 120 can facilitate the time delay for the predefined time by controlling one or more individual pumps 160 and/or the metering devices 170 for some or all corresponding ingredients and/or sources 130, 140, 150.

In one aspect of an embodiment, a command is received via a user interface, wherein a user can initiate the command to prime or purge the product dispenser with a single user command entry.

In one aspect of an embodiment, a plurality of beverage supply lines can be in communication with at least one of the following: one or more ingredient packages; one or more ingredient cartridges, one or more beverage boxes, one or more beverage bags, or one or more beverage containers.

Block 404 is followed by block 406, in which at least a second portion of the product is dispensed. For example, in the embodiment shown with reference to FIGS. 1 and 2, the control device 120 can access one or more recipe adjustments or other predefined product recipes stored in memory, such as 124, or another data storage device, and can facilitate activation of one or more individual pumps 160 and/or the metering devices 170 for some or all corresponding ingredients and/or sources 130, 140, 150. The control device 120 can facilitate dispensing at least the second portion of the selected beverage or product via a dispenser nozzle, such as 180.

The method 400 of FIG. 3 ends after block 406.

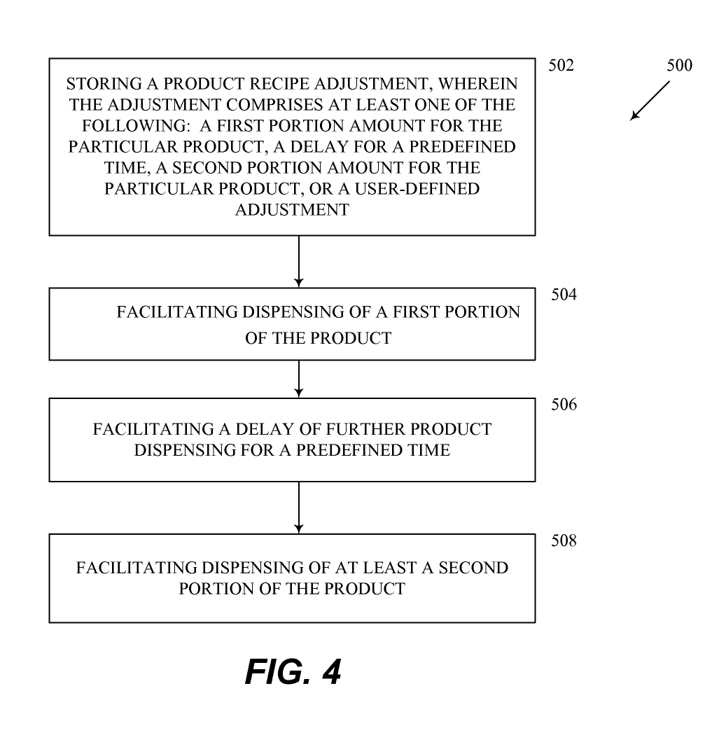

FIG. 4 is a process flowchart illustrating an example method in accordance with an embodiment of the invention. The example method 500 shown in FIG. 4 provides a method for operating a product dispenser. In particular, the method 500 is a method for operating a product dispenser with a plurality of beverage ingredient sources comprising a respective beverage ingredient, a plurality of beverage supply lines in respective communication with the plurality of ingredient sources, and at least one pump in communication with the plurality of beverage supply lines. The method 500 can be implemented by various system or product dispenser components shown in FIG. 1, such as 100 of FIG. 1.

The method 500 begins at block 502. In block 502, a product recipe adjustment is stored, wherein the adjustment comprises at least one of the following: a first portion amount for the particular product, a delay for a predefined time, or a second portion amount for the particular product. dispensing a first portion of a product. For example, in the embodiment shown with reference to FIGS. 1 and 2, a product recipe adjustment, such as a recipe adjustment or other predefined product recipe, can be stored in memory, such as 124, or another data storage device. As described above, a suitable recipe adjustment can include one or more of the following: a first amount of product or beverage to dispense; a first set of base products, product components, or ingredient sources; at least one time delay, a second amount of product or beverage to dispense; a second set of base products, product components, or ingredient sources; a subsequent amount of product or beverage to dispense; a subsequent set of base products, product components, or ingredient sources; and user-entered data operable to adjust a recipe. In any instance, a control device, such as 120, may receive a recipe adjustment or other predefined product recipe, and store the recipe adjustment or predefined product recipe in the memory 124 or other data storage device for subsequent access.

In one aspect of an embodiment, a storing a plurality of product recipe adjustments, wherein based at least in part on a particular product to be dispensed, a respective product recipe adjustment is provided to the product dispenser.

In one aspect of an embodiment, a first portion amount comprises a percentage amount to dispense for a particular product, a delay for a predefined time comprises an amount of time measured in seconds, and at least a second portion amount comprises a remaining percentage amount to dispense for the particular product.

Block 502 is followed by block 504, in which dispensing of a first portion of the product is facilitated. For example, in the embodiment shown with reference to FIGS. 1 and 2, a user can select a desired product or beverage using a product button, such as 302, or other command via an interface 110, 300. A control device, such as 120, can access the memory 124 or other data storage device to determine whether, based at least in part on a stored recipe adjustment or other predefined product recipe, corresponding instructions exist for the desired beverage. If so, then the control device 120 can proceed with dispensing at least a first portion of the product or beverage according to the stored recipe adjustment or other predefined product recipe. The control device 120 can facilitate activation of one or more individual pumps 160 and/or the metering devices 170 for some or all desired ingredients and/or sources 130, 140, 150 corresponding to the desired product or beverage, and dispense at least a first portion of the product or beverage.

Block 504 is followed by block 506, in which a delay of further product dispensing for a predefined time is facilitated. For example, in the embodiment shown in FIGS. 1 and 2, a control device, such as 120, can access the memory 124 or other data storage device to determine whether, based at least in part on a stored recipe adjustment or other predefined product recipe, corresponding instructions exist for the desired beverage. If so, the control device 120 can receive a predefined time from the instructions, and can facilitate operation of the respective individual pumps 160 and/or the metering devices 170 for the respective ingredients and/or sources 130, 140, 150 to delay further dispensing of any ingredients or sources.

Block 506 is followed by block 508, in which dispensing of at least a second portion of the product is facilitated. For example, in the embodiment shown with reference to FIGS. 1 and 2, a control device, such as 120, can access the memory 124 or other data storage device to determine whether, based at least in part on a stored recipe adjustment or other predefined product recipe, corresponding instructions exist for the desired beverage. If so, then the control device 120 can proceed with dispensing at least a second portion of the product or beverage according to the stored recipe adjustment or other predefined product recipe. The control device 120 can facilitate activation of one or more individual pumps 160 and/or the metering devices 170 for some or all desired ingredients and/or sources 130, 140, 150 corresponding to the desired product or beverage, and dispense at least a second portion of the product or beverage.

In one aspect of an embodiment, some or all of the above elements can be repeated if necessary to pour or dispense multiple portions of a product or beverage depending on the product or beverage composition, carbonation, flavor, or other characteristic.

The method 500 of FIG. 4 ends after block 508.

The example elements of FIGS. 3 and 4 are shown by way of example, and other process embodiments can have fewer or greater numbers of elements, and such elements can be arranged in alternative configurations in accordance with other embodiments of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational elements or steps to be performed on the computer or other programmable apparatus to produce a computer implemented process such that the instructions that execute on the computer or other programmable apparatus provide elements for implementing the functions specified in the flowchart block or blocks.

Accordingly, blocks of the block diagrams and flowchart illustrations support combinations of means for performing the specified functions, combinations of elements or steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions, elements, or combinations of special purpose hardware and computer instructions.

The capabilities of various embodiments of the invention can be implemented in software, firmware, hardware or some combination thereof.

As one example, one or more aspects of the invention can be included in an article of manufacture (e.g., one or more computer program products) having, for instance, computer usable media. The media has embodied therein, for instance, computer readable program code means for providing and facilitating the capabilities of the embodiment of the invention. The article of manufacture can be included as a part of a computer system or sold separately.

Additionally, at least one program storage device readable by a machine, tangibly embodying at least one program or set of instructions executable by the machine to perform the capabilities of the embodiment of the invention can be provided.

The flow diagrams depicted herein are examples. There may be many variations to these diagrams or the elements (or operations) described therein without departing from the scope of the claimed invention. For instance, the elements may be performed in a differing order, or elements may be added, deleted or modified. All of these variations are considered a part of the claimed inventions.

While embodiments of the invention have been described, it will be understood that those skilled in the art, both now and in the future, may make various improvements and enhancements which fall within the scope of the claims which follow. These claims should be construed to maintain the proper protection for the invention first described.

The claimed invention is:

1. A product dispenser, comprising:
a plurality of beverage ingredient sources comprising a respective beverage ingredient;
a plurality of beverage supply lines in respective communication with the plurality of ingredient sources;
at least one pump in communication with the plurality of beverage supply lines;
a controller in communication with the at least one pump and operable to execute a set of instructions operable to:
dispense a first portion of a beverage;
delay further dispensing for a predefined time; and
dispense at least a second portion of the beverage.

2. The system of claim 1, the controller further operable to:
provide a beverage recipe adjustment, wherein the adjustment comprises at least one of the following: a first portion amount for a particular beverage, a delay for a predefined time, a second portion amount for a particular beverage, or a user-defined adjustment.

3. The system of claim 1, the controller further operable to:
provide a beverage recipe adjustment, wherein the adjustment comprises a percentage amount to dispense for a particular beverage, a predefined time to delay, or a remaining percentage amount to dispense for the particular beverage, or a user-defined adjustment.

4. The system of claim 1, the controller further operable to:
based at least in part on a particular beverage to be dispensed, provide a beverage recipe adjustment, wherein the adjustment comprises at least one of the following: a first portion amount for the particular beverage, a delay for a predefined time, a second portion amount for the particular beverage, or a user-defined adjustment.

5. The system of claim 1, the controller further operable to:
based at least in part on a particular beverage to be dispensed, provide a beverage recipe adjustment, wherein the adjustment comprises a percentage amount to dispense for a particular beverage, a predefined time to delay, a remaining percentage amount to dispense for the particular beverage, or a user-defined adjustment.

6. The system of claim 1, further comprising:
a database module operable to provide the controller with a beverage recipe adjustment, wherein based at least in part on a particular beverage to be dispensed, the adjustment comprises at least one of the following: a first portion amount for the particular beverage, a delay for a predefined time, a second portion amount for the particular beverage, or a user-defined adjustment.

7. The system of claim 1, further comprising:
a database module operable to provide the controller with a beverage recipe adjustment, wherein based at least in part on a particular beverage to be dispensed, provide a beverage recipe adjustment, wherein the adjustment comprises a percentage amount to dispense for a particular beverage, a predefined time to delay, a remaining percentage amount to dispense for the particular beverage, or a user-defined adjustment.

8. A computer program product, comprising a computer readable medium having computer readable program code, the computer readable program code operable to be executed to implement a method for adjusting a recipe for a product dispenser, the method comprising:
dispensing a first portion of a product;
delaying further dispensing for a predefined time; and
dispensing at least a second portion of the product.

9. The computer program product of claim 8, the method further comprising:
providing a product recipe adjustment, wherein the adjustment comprises at least one of the following: a first portion amount for a particular product, a delay for a predefined time, a second portion amount for a particular product, or a user-defined adjustment.

10. The computer program product of claim 8, the method further comprising:
providing a product recipe adjustment, wherein the adjustment comprises a percentage amount to dispense for a particular product, a predefined time to delay, a remaining percentage amount to dispense for the particular product, or a user-defined adjustment.

11. The computer program product of claim 8, the method further comprising:
based at least in part on a particular product to be dispensed, providing a product recipe adjustment, wherein the adjustment comprises at least one of the following: a first portion amount for the particular product, a delay for a predefined time, a second portion amount for the particular product, or a user-defined adjustment.

12. The computer program product of claim 8, the method further comprising:
based at least in part on a particular product to be dispensed, providing a product recipe adjustment, wherein the adjustment comprises a percentage amount to dispense for a particular product, a predefined time to delay, a remaining percentage amount to dispense for the particular product, or a user-defined adjustment.

13. A method for adjusting a product recipe for a product dispenser, the method comprising:
dispensing a first portion of a product;
delaying further dispensing for a predefined time; and
dispensing at least a second portion of the product.

14. The method of claim 13, the method further comprising:
obtaining a product recipe adjustment, wherein the adjustment comprises at least one of the following: a first portion amount for a particular product, a delay for a predefined time, a second portion amount for a particular product, or a user-defined adjustment.

15. The method of claim 13, the method further comprising:
obtaining a product recipe adjustment, wherein the adjustment comprises a percentage amount to dispense for a particular product, a predefined time to delay, or a remaining percentage amount to dispense for the particular product, or a user-defined adjustment.

16. The method of claim 13, the method further comprising:
based at least in part on a particular product to be dispensed, obtaining a product recipe adjustment, wherein the adjustment comprises at least one of the following: a first portion amount for the particular product, a delay for a predefined time, a second portion amount for the particular product, or a user-defined adjustment.

17. The method of claim 13, the method further comprising:
based at least in part on a particular product to be dispensed, obtaining a product recipe adjustment, wherein the adjustment comprises a percentage amount to dispense for a particular product, a predefined time to delay, a remaining percentage amount to dispense for the particular product, or a user-defined adjustment.

18. A method for adjusting a product recipe for a product dispenser, the method comprising:
storing a product recipe adjustment, wherein the adjustment comprises at least one of the following: a first portion amount for the particular product, a delay for a predefined time, or a second portion amount for the particular product. dispensing a first portion of a product;
facilitating dispensing of a first portion of the product;
facilitating a delay of further product dispensing for a predefined time; and
facilitating dispensing of at least a second portion of the product.

19. The method of claim 18, further comprising:
storing a plurality of product recipe adjustments, wherein based at least in part on a particular product to be dispensed, a respective product recipe adjustment is provided to the product dispenser.

20. The method of claim 18, wherein the first portion amount comprises a percentage amount to dispense for a particular product, the delay for a predefined time comprises an amount of time measured in seconds, and the at least a second portion amount comprises a remaining percentage amount to dispense for the particular product.
